(19) United States
(12) Patent Application Publication
(10) Pub. No.: US 2022/0295762 A1
(43) Pub. Date: Sep. 22, 2022

(54) Vivaria Assembly

(71) Applicant: Derrick Mosley, Cleveland, OH (US)

(72) Inventor: Derrick Mosley, Cleveland, OH (US)

(21) Appl. No.: 17/203,882

(22) Filed: Mar. 17, 2021

(51) Int. Cl. A01K 63/04; A01K 63/06; A01K 1/00

(52) U.S. Cl. CPC A01K 63/042; A01K 63/065; A01K 1/0076

(57) ABSTRACT

A vivaria assembly for separating aquatic animals and plants from terrestrial animals and plants includes a container and a set of panels. The panels are engaged to the container and positioned in an interior space defined by the container. Each panel extends from a bottom to proximate to a top of the container so that the container and the panels define a plurality of compartments within the interior space. The panels and at least a portion of a wall of the container are substantially transparent. A plurality of cutouts is positioned in the container so that each compartment has at least one cutout permitting access to the compartment. A respective habitat element and at least one of an animal and a plant can be inserted into each compartment to create a respective vivarium within the compartment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vivaria assemblies and more particularly pertains to a new vivaria assembly for separating aquatic animals and plants from terrestrial animals and plants. The present invention discloses a vivaria assembly comprising a container having a set of panels positioned in the container defining a plurality of compartments, wherein each compartment is configured for insertion of a respective habitat element and at least one of an animal and a plant, for creating a variety of vivaria within the plurality of compartments.

### (2) Description of Related Art Including Information Disclosed Under 37 CFR 1.97 and 1.98

The prior art relates to vivaria assemblies. Prior art vivaria assemblies may comprise containers having divider walls for terracing or for separating aquatic and terrestrial elements for display purposes. What is lacking in the prior art is a vivaria assembly comprising a container having a set of panels positioned in the container defining a plurality of compartments, wherein each compartment is configured for insertion of a respective habitat element and at least one of an animal and a plant, for creating a variety of vivaria within the plurality of compartments.

### BRIEF SUMMARY OF THE INVENTION

An embodiment of the disclosure meets the needs presented above by generally comprising a container and a set of panels. The panels are engaged to the container and positioned in an interior space defined by the container. Each panel extends from a bottom to proximate to a top of the container so that the container and the panels define a plurality of compartments within the interior space. The panels and at least a portion of a wall of the container are substantially transparent. A plurality of cutouts is positioned in the container so that each compartment has at least one cutout permitting access to the compartment. Each compartment thus is configured for insertion of a respective habitat element and at least one of an animal and a plant to create a respective vivarium within the compartment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vivaria assembly according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a cross-sectional view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

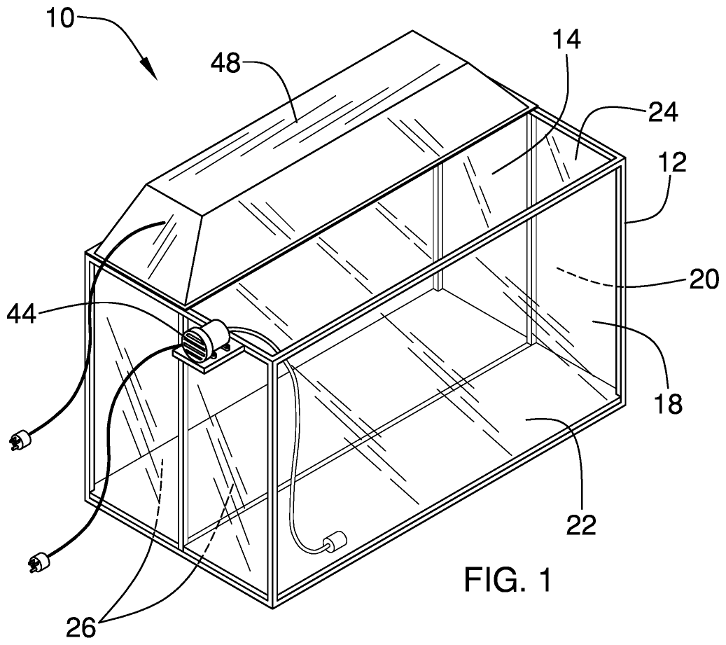

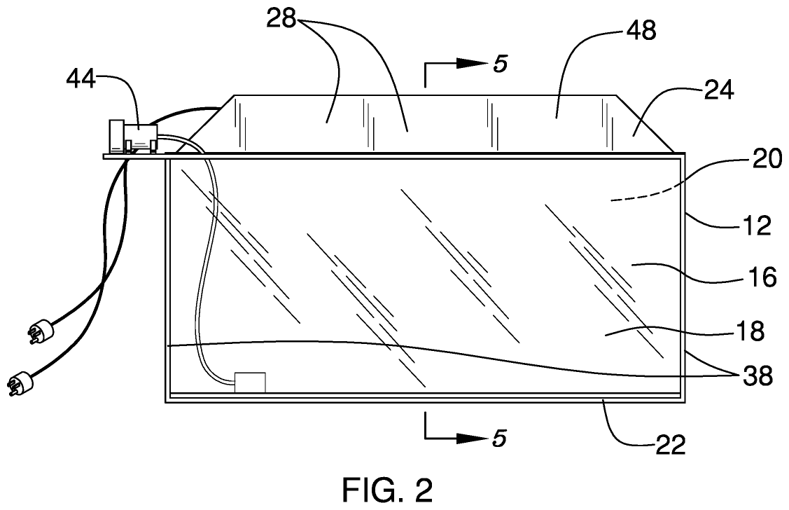

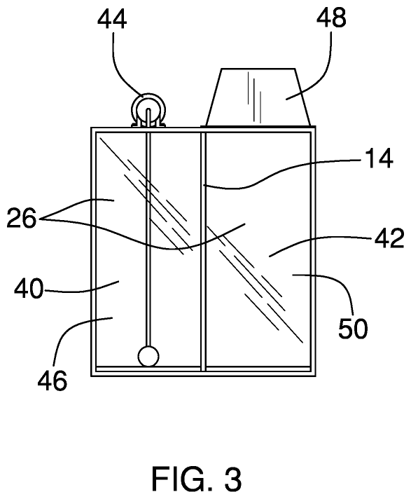

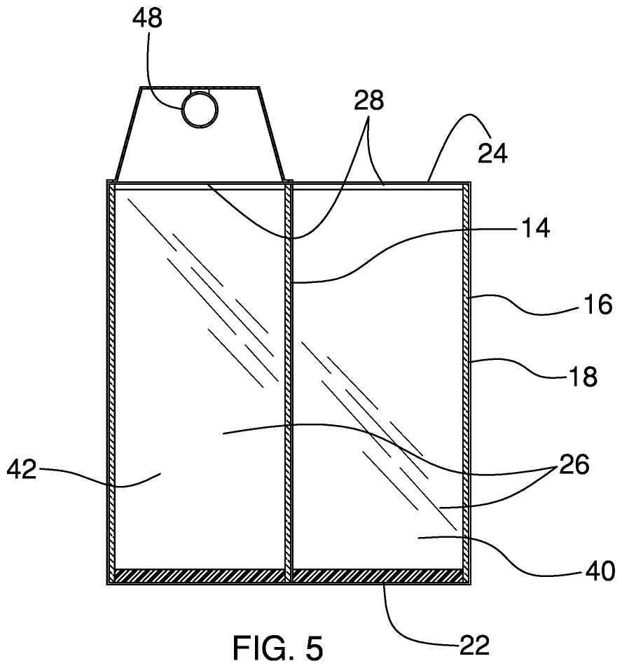

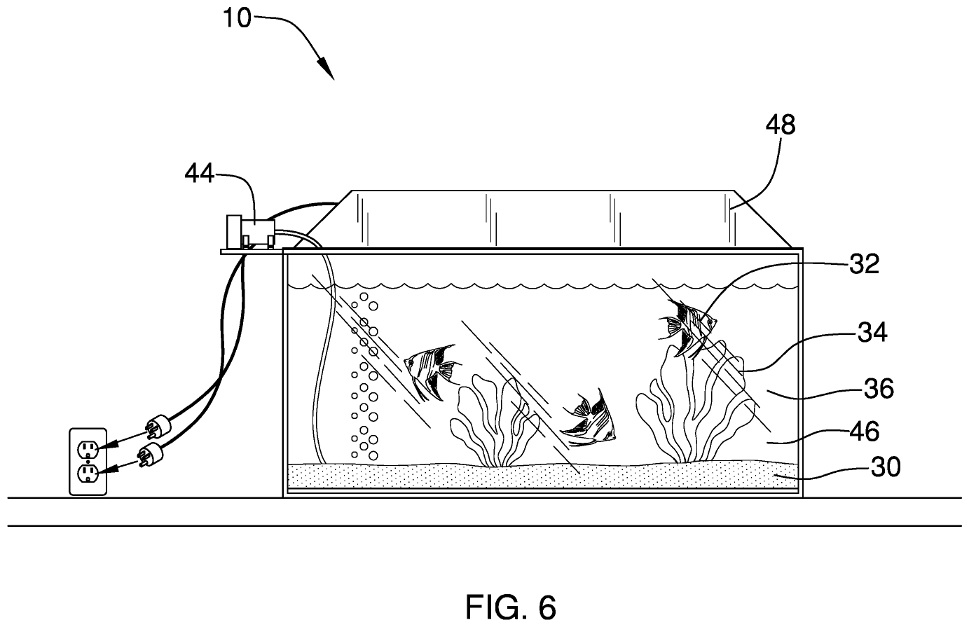

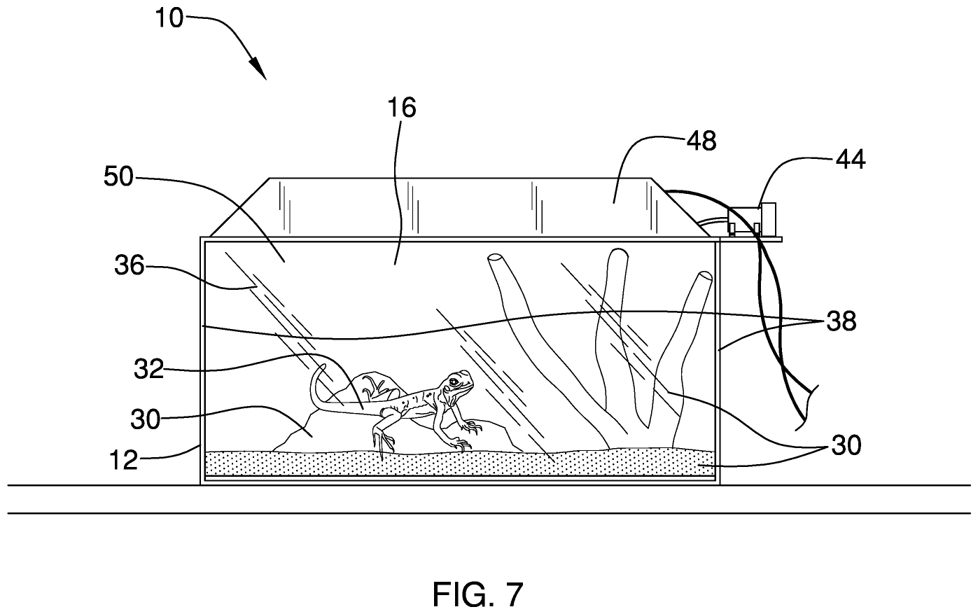

With reference now to the drawings, and in particular to FIGS. 1 through 7 thereof, a new vivaria assembly embodying the principles and concepts of an embodiment of the disclosure and generally designated by the reference numeral 10 will be described.

As best illustrated in FIGS. 1 through 7, the vivaria assembly 10 generally comprises a container 12 and a set of panels 14. The container 12 may be cubical, as shown in FIG. 1, cuboidal, spherical, and the like. At least a portion 16 of a wall 18 of the container 12 is substantially transparent. As shown in FIG. 1, the entire wall 18 is transparent.

The panels 14 are engaged to the container 12 and positioned in an interior space 20 defined by the container 12. Each panel 14 extends from a bottom 22 to proximate to a top 24 of the container 12 so that the container 12 and the panels 14 define a plurality of compartments 26 within the interior space 20. The panels 14 are substantially transparent.

A plurality of cutouts 28 is positioned in the container 12 so that each compartment 26 has at least one cutout 28 permitting access to the compartment 26. Each compartment 26 thus is configured for insertion of a respective habitat element 30 and at least one of an animal 32 and a plant 34 to create a respective vivarium 36 within the compartment 26.

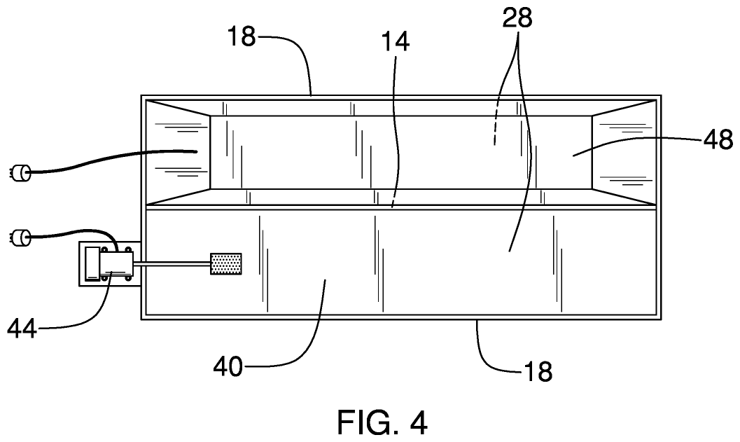

The panels 14 and the container 12 comprise glass, plastic, or the like. The set of panels 14 may comprise one panel 14, as shown in FIG. 4. The panel 14 is engaged to and extends between opposed sides 38 of the container 12 defining a first chamber 40 and a second chamber 42. As shown in FIG. 4, the plurality of cutouts 28 encompasses the top 24 of the container 12.

A pump 44 is engaged to the container 12 and is configured to pump air into the first chamber 40. The pump 44 is configured to aerate water positioned in the first chamber 40 so that the respective vivarium 36 is configured to function as an aquarium 46. The present invention anticipates positioning of a variety of habitat elements 30 into the aquarium 46, such as, but not limited to, water, salt, sand, rocks, corral, and the like, along with a variety of plants 34 and animals 32, such as kelp, freshwater fishes, saltwater fishes, and the like.

A lamp 48 is engaged to the container 12 and is configured to illuminate and to heat the second chamber 42, so that the respective vivarium 36 is configured to function as a terrarium 50. The present invention anticipates positioning of a variety of habitat elements 30 into the terrarium 50, such as, but not limited to, water, sand, rocks, and the like, along with a variety of plants 34 and animals 32, such as grasses, trees, reeds, mammals, reptiles, amphibians, insects, arachnids, birds, and the like.

In use, the compartments 26 are populated with respective habitat elements 30, animals 32, and plants 34 to create a variety of vivaria 36. The vivaria 36, being visible through the wall 18 of the container 12 and the panels 14, fulfill entertainment and educational functions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vivaria assembly comprising:
a container defining an interior space;
a panel engaged to the container and positioned in the interior space, the panel extending from a bottom to proximate to a top of the container, such that the container and the panel define a plurality of compartments within the interior space, the panel and at least a portion of a wall of the container being substantially transparent, the panel extending between opposed sides of the container defining a first chamber and a second chamber; and
a plurality of cutouts positioned in the container, such that each compartment has at least one cutout permitting access to the compartment, wherein each compartment is configured for insertion of a respective habitat element and at least one of an animal and a plant, for creating a respective vivarium within the compartment; and
a pump engaged to the container, the pump being positioned on a pump stand extending laterally from the container coplanar with the top of the container, the pump being configured for pumping air into the first chamber, wherein the pump is configured for aerating water positioned in the first chamber, such that the first chamber is configured for functioning as an aquarium.

2. The vivaria assembly of claim 1, wherein the panel and the container comprise glass or plastic.

3. (canceled)

4. The vivaria assembly of claim 1, wherein the plurality of cutouts encompasses the top of the container.

5. (canceled)

6. The vivaria assembly of claim 4, further including a lamp engaged to the container and being configured for illuminating and heating the second chamber, such that the second chamber is configured for functioning as a terrarium.

7. The vivaria assembly of claim 1, wherein the container is cuboidal, cubical, or spherical.

8. A vivaria system comprising:
a container defining an interior space;
a panel engaged to the container and positioned in the interior space, said panel extending from a bottom to proximate to a top of the container, such that the container and the panel define a plurality of compartments within the interior space, the panel and at least a portion of a wall of the container being substantially transparent; and
a plurality of cutouts positioned in the container, such that each compartment has at least one cutout permitting access to the compartment;
a respective habitat element and at least one of an animal and a plant positioned in each compartment, such that each compartment comprises a respective vivarium; and
a pump engaged to the container, the pump being positioned on a pump stand extending laterally from the container coplanar with the top of the container, the pump being configured for pumping air into the first chamber, wherein the pump is configured for aerating water positioned in the first chamber, such that the first chamber is configured for functioning as an aquarium.

9. The vivaria system of claim 8, wherein the panel and the container comprise glass or plastic.

10. (canceled)

11. The vivaria system of claim 1, wherein the plurality of cutouts encompasses the top of the container.

12. (canceled)

13. The vivaria system of claim 11, further including a lamp engaged to the container and being configured for illuminating and heating the second chamber, such that the respective vivarium is a terrarium.

14. The vivaria assembly of claim 8, wherein the container is cuboidal, cubical, or spherical.

15. A vivaria assembly comprising:
a container defining an interior space, the container being cuboidal, cubical, or spherical;
a panel engaged to the container and positioned in the interior space, the panel extending from a bottom to proximate to a top of the container, such that the container and the panel define a plurality of compartments within the interior space, the panel and at least a portion of a wall of the container being substantially transparent, the panel and the container comprising glass or plastic, the panel being engaged to and extending between opposed sides of the container defining a first chamber and a second chamber;
a plurality of cutouts positioned in the container, such that each compartment has at least one cutout permitting access to the compartment, wherein each compartment is configured for insertion of a respective habitat element and at least one of an animal and a plant, for creating a respective vivarium within the compartment, the plurality of cutouts encompassing the top of the container;
a pump engaged to the container, the pump being positioned on a pump stand extending laterally from the container coplanar with the top of the container, the pump being configured for pumping air into the first chamber, wherein the pump is configured for aerating water positioned in the first chamber, such that the respective vivarium is configured for functioning as an aquarium; and
a lamp engaged to the container and being configured for illuminating and heating the second chamber, such that the respective vivarium is configured for functioning as a terrarium.
